(19) United States
(12) Patent Application Publication
(10) Pub. No.: US 2025/0136372 A1
(43) Pub. Date: May 1, 2025

(54) SYSTEMS AND METHODS FOR OPERATING A COMPACTION SYSTEM OF A REFUSE VEHICLE

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Elmira, NY (US); Johnny Bui, Oshkosh, WI (US); Nagabhushana Sharma Gurumurthy, Oshkosh, WI (US)

(73) Assignee: Oshkosh Corporation, Oshkosh, WI (US)

(21) Appl. No.: 18/924,681

(22) Filed: Oct. 23, 2024

Related U.S. Application Data
(60) Provisional application No. 63/545,981, filed on Oct. 27, 2023.

(51) Int. Cl. B65F 3/20; B65F 3/14

(52) U.S. Cl. CPC B65F 3/20; B65F 2003/146

(57) ABSTRACT

A refuse vehicle includes a chassis, a body coupled to the chassis, a compaction system, a camera, and one or more processing circuits. The body defines a refuse compartment configured to store refuse therein. The one or more processing circuits are configured to acquire, from the camera, image data corresponding to an object associated with refuse acquired by the refuse vehicle, determine, based on the image data, a refuse category associated with the object, determine, based on the refuse category, a first packing profile for the compaction system, and operate the compaction system according to the first packing profile. The first packing profile includes at least one packing parameter associated with operation of the compaction system.

### CROSS-REFERENCE TO RELATED PATENT APPLICATION

This application claims the benefit of and priority to U.S. Provisional Patent Application No. 63/545,981, filed Oct. 27, 2023, which is incorporated herein by reference in its entirety.

### BACKGROUND

The present disclosure generally relates to the field of refuse vehicles. More specifically, the present disclosure relates to control systems for refuse vehicles.

### SUMMARY

One embodiment of the present disclosure relates to a refuse vehicle. The refuse vehicle includes a chassis, a body coupled to the chassis, a compaction system, a camera, and one or more processing circuits. The body defines a refuse compartment configured to store refuse therein. The one or more processing circuits are configured to acquire, from the camera, image data corresponding to an object associated with refuse acquired by the refuse vehicle, determine, based on the image data, a refuse category associated with the object, determine, based on the refuse category, a first packing profile for the compaction system, and operate the compaction system according to the first packing profile. The first packing profile includes at least one packing parameter associated with operation of the compaction system.

Another embodiment of the present disclosure relates to a compactor control system for operating a refuse vehicle. The compactor control system includes a compaction actuator configured to compact refuse stored within a refuse compartment of the refuse vehicle, a camera, and one or more processing circuits communicably coupled to the compaction actuator and the camera. The one or more processing circuits are configured to acquire, from the camera, image data corresponding to an object associated with refuse acquired by the refuse vehicle, determine, based on the image data, a refuse category associated with the object, determine, based on the refuse category, a first packing profile for the compaction actuator, and operate the compaction actuator according to the first packing profile. The first packing profile includes at least one packing parameter associated with operation of the compaction system.

Yet another embodiment of the present disclosure relates to a method for operating a compaction system of a refuse vehicle. The method includes acquiring, from a camera, image data corresponding to an object positioned within a refuse compartment of the refuse vehicle, determining, based on the image data, a refuse category associated with the object, determining, based on the refuse category, a first packing profile for the compaction system, and operating the compaction system according to the first packing profile. The compaction system is configured to compact refuse stored within the refuse compartment.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is a top perspective view of a side-loading refuse vehicle, according to an exemplary embodiment;

FIG. 7 is a rear perspective view of a rear-loading refuse vehicle, according to an exemplary embodiment;

FIG. 8 is a top perspective view of a refuse compartment of the side-loading refuse vehicle of FIG. 6, according to an exemplary embodiment;

FIG. 9 is a side view of a refuse compartment of the rear-loading refuse vehicle of FIG. 7, according to an exemplary embodiment;

FIG. 10 is a section view of the refuse compartment of FIG. 9 with a tailgate compaction assembly configured as a slide, according to an exemplary embodiment;

FIG. 11 is a section view of the refuse compartment of FIG. 9 with a tailgate compaction assembly configured as a sweep with a linear actuator, according to an exemplary embodiment;

FIG. 12 is a section view of the refuse compartment of FIG. 9 with a tailgate compaction assembly configured as a sweep with a rotational actuator, according to an exemplary embodiment;

FIG. 13 is a section view of the refuse compartment of FIG. 8 with a packer system in a retracted configuration, according to an exemplary embodiment;

FIG. 14 is a section view of the refuse compartment of FIG. 8 with a packer system in a partially extended configuration, according to an exemplary embodiment;

FIG. 15 is a section view of the refuse compartment of FIG. 8 with a packer system in an extended configuration, according to an exemplary embodiment;

FIG. 16 is a section view of the refuse compartment of FIG. 8 with a packer system in a retracted configuration, according to an exemplary embodiment;

FIG. 17 is a section view of the refuse compartment of FIG. 8 with a packer system in a partially extended configuration, according to an exemplary embodiment;

FIG. 18 is a section view of the refuse compartment of FIG. 8 with a packer system in an extended configuration, according to an exemplary embodiment;

FIG. 19 is a perspective view of the refuse compartment of FIG. 8 with an object recognition system, according to an exemplary embodiment;

FIG. 20 is a perspective view of the refuse compartment of FIG. 8 with an object recognition system, according to an exemplary embodiment;

FIG. 21 is a perspective view of the refuse compartment of FIG. 8 with an object recognition system, according to an exemplary embodiment;

FIG. 22 is a perspective view of the refuse compartment of FIG. 9 with an object recognition system, according to an exemplary embodiment;

FIG. 23 is a block diagram of a control system for any of the refuse vehicles of FIGS. 1-3, according to an exemplary embodiment;

FIG. 24 is a block diagram of a controller of the control system of FIG. 23, according to an exemplary embodiment;

FIG. 25 is a block diagram of a controller of the control system of FIG. 23, according to an exemplary embodiment;

FIG. 26 is an illustration of a configuration of a user interface generated by the controller of FIG. 25, according to example embodiments; and

FIG. 27 is an illustration of a configuration of a user interface generated by the controller of FIG. 25, according to example embodiments.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, a refuse vehicle includes an object recognition system configured to determine a category of an object (e.g., a type of refuse and/or another characteristic of the refuse, etc.) associated with the refuse vehicle using sensors. For example, a camera may be positioned such that a field of view of the camera is positioned to include a hopper volume of a refuse compartment of the refuse vehicle. One or more processing circuits (e.g., processing circuitry, etc.) of the refuse vehicle may obtain image data from the camera that can be analyzed to determine a category of the refuse (e.g., refuse material(s), etc.) contained within the hopper volume. The one or more processing circuits may then determine a packing profile associated with the category of the refuse. For example, the one or more processing circuits may be configured to determine operational parameters for a compaction system of the refuse vehicle based on the category of the refuse. The compaction system may be configured to compact refuse within a storage volume of the refuse vehicle to reduce a volume of the refuse stored within the storage volume. The operational parameters for the packing profiles may be preselected to improve operation of the compaction system with regards to the category of the refuse. The one or more processing circuits may operate the compaction system of the refuse vehicle according to the packing profile or may generate an alert to notify an operator of the refuse vehicle that the refuse vehicle is not operating according to the packing profile.

### Refuse Vehicle

### Front-Loading Configuration

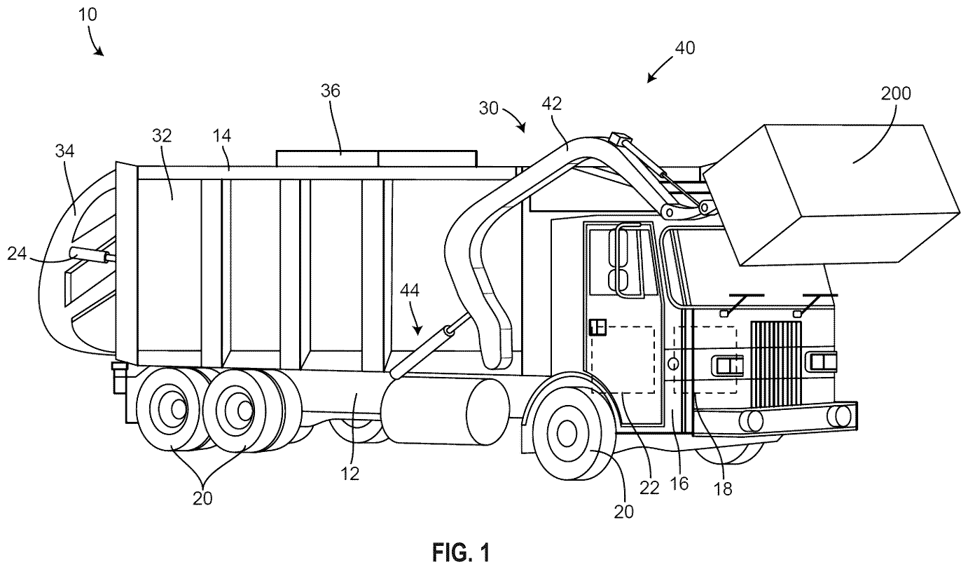

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as tractive elements 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

### Rear-Loading Configuration

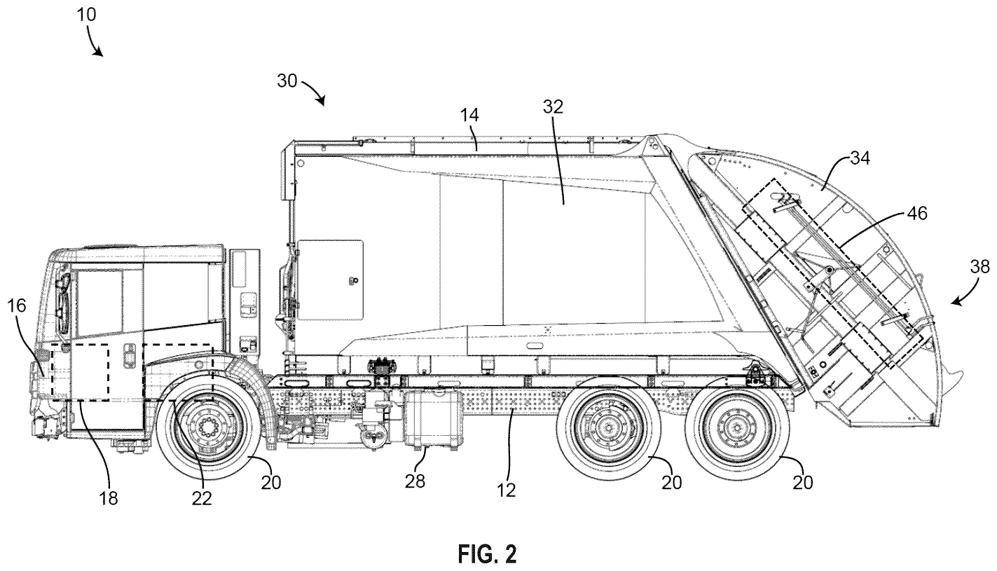

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

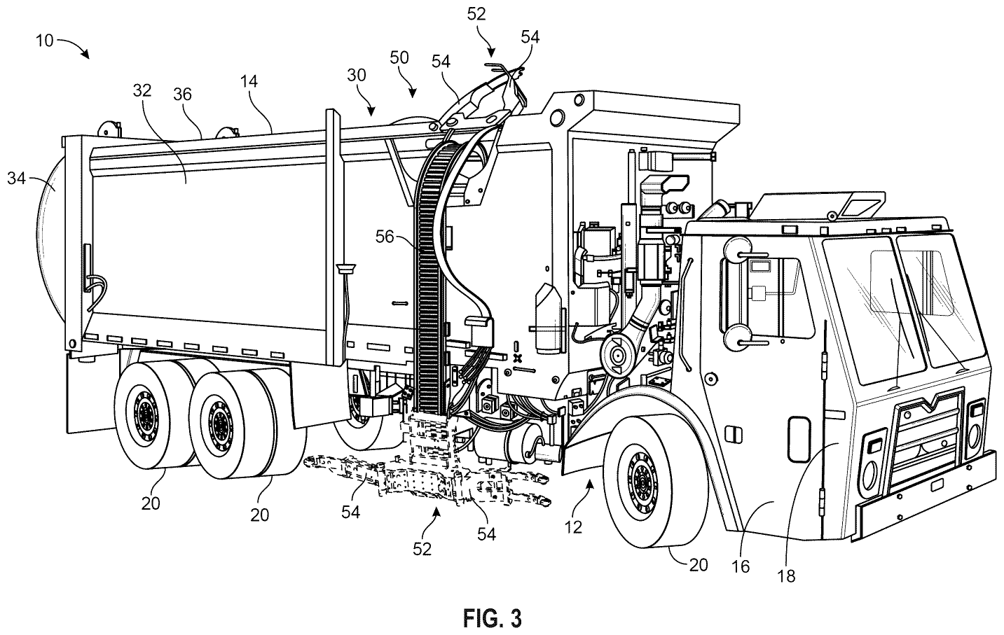

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

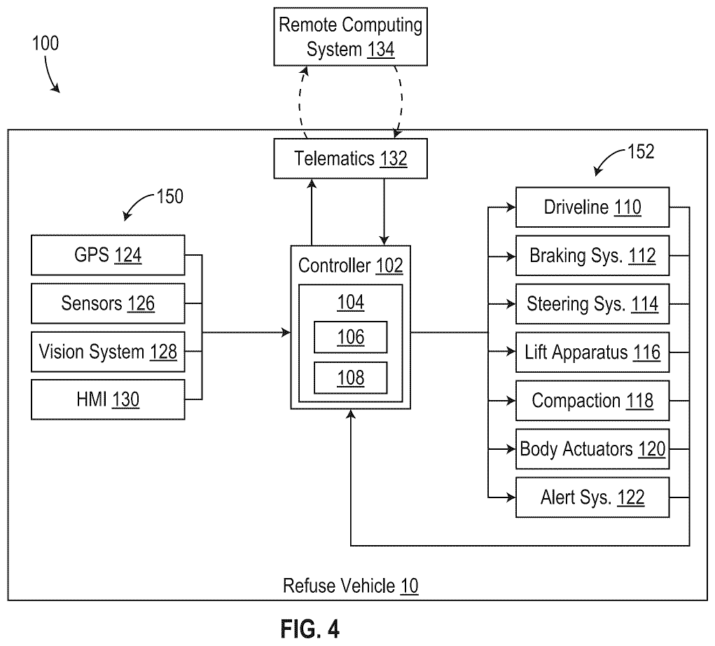

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. The processing circuitry 104 may include one or more processing circuits. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS system 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

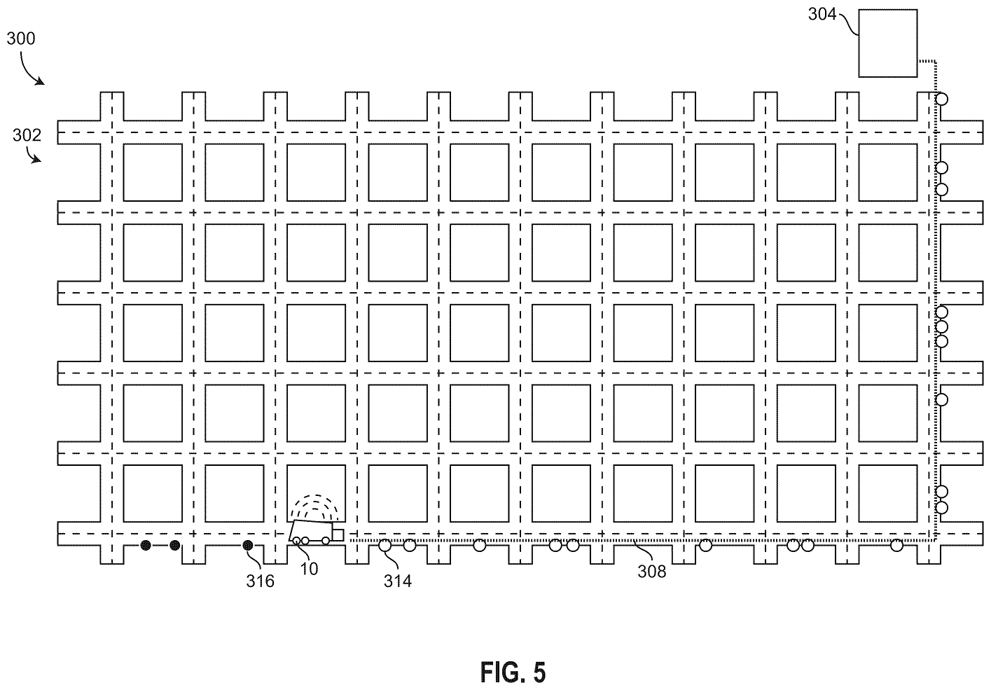

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Refuse Compartment

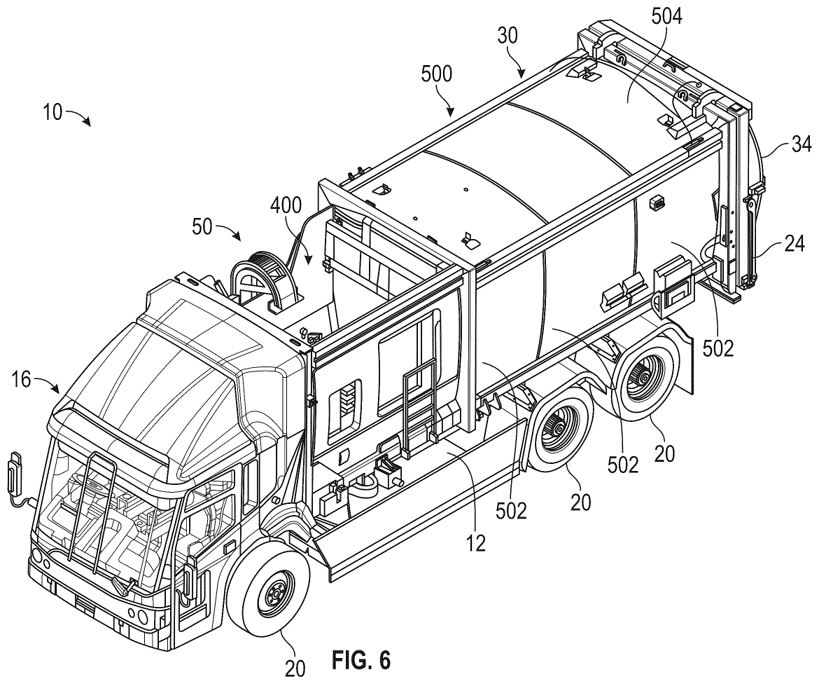

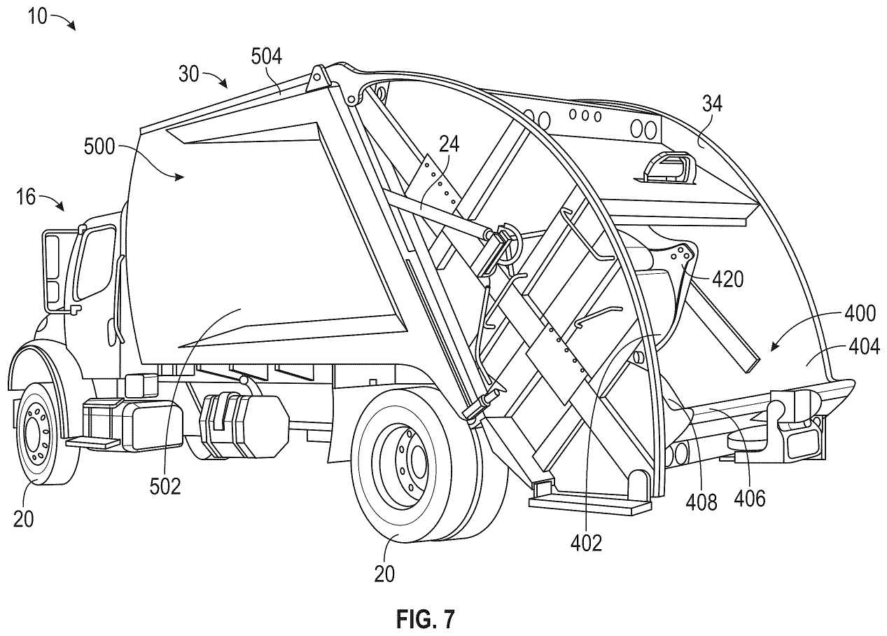

Referring to FIGS. 6 and 7, the refuse compartment 30 defines a hopper volume 400 and a storage volume 500. In this regard, refuse may be initially loaded into the hopper volume 400 and later compacted into the storage volume 500. According to the exemplary embodiment shown in FIG. 5, the hopper volume 400 is positioned between the storage volume 500 and the cab 16 (e.g., refuse is loaded into a portion of the refuse compartment 30 behind the cab 16 and stored in a portion further toward the rear of the refuse compartment 30, in a front loading refuse vehicle, in a side loading refuse vehicle, etc.). According to the exemplary embodiment shown in FIG. 6, the storage volume 500 is be positioned between the hopper volume 400 and the cab 16 (e.g., in a rear-loading refuse truck, etc.).

FIG. 7 illustrates an exemplary embodiment of the refuse compartment 30 of the refuse vehicle 10. As shown in FIG. 7, the hopper volume 400 is an internal volume positioned in the tailgate 34 and is defined by a left sidewall 402, a right sidewall 404, a hopper floor 406, a holding plate 408, and a tailgate compaction assembly 420. The left sidewall 402 and the right sidewall 404 extend between the hopper floor 406 and the holding plate 408. In general, the hopper floor 406 is configured to support refuse contained in the hopper volume 400 prior to the refuse being transferred to the storage volume 500. In some embodiments, the hopper floor 406 may be configured in a bowl shape to receive and store refuse. The holding plate 408 extends at a downward angle (e.g., in a direction partially perpendicular to the ground on which the refuse vehicle 10 travels, etc.) from the storage volume 500 to the hopper floor 406. In general, the holding plate 408 separates the hopper volume 400 and the storage volume 500 and forms a partition between the two sections in the refuse compartment 30. In some embodiments, the holding plate 408 may define a hopper aperture configured to selectively allow refuse to transfer from the hopper volume 400 to the storage volume 500. In addition, the holding plate 408 aids in preventing refuse being packed into the storage volume 500 from falling back toward the hopper volume 400. The tailgate compaction assembly 420 is part of the compaction system 118 and is configured to transfer refuse from the hopper volume 400 to the storage volume 500. In some embodiments, the tailgate compaction assembly 420 compacts refuse into the storage volume 500 (e.g., compresses the refuse, the tailgate compaction assembly 420 is the packer 46, etc.). In other embodiments, the tailgate compaction assembly 420 transfers the refuse from the hopper volume 400 to the storage volume 500 and the packer 46 separately compacts the refuse in the storage volume 500.

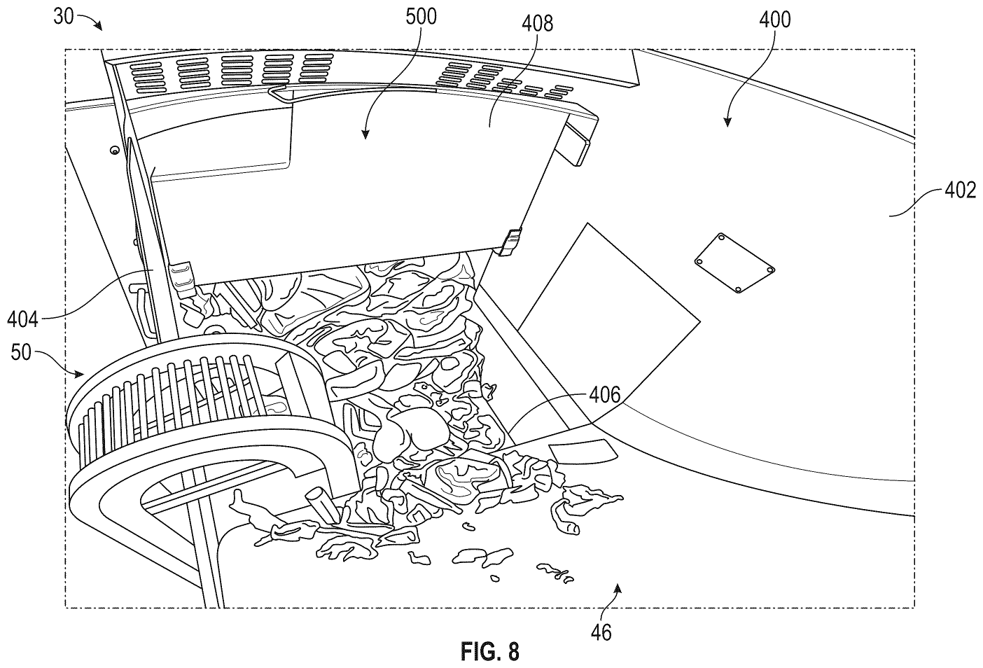

FIG. 8 illustrates an exemplary embodiment of the refuse compartment 30 of the refuse vehicle 10. As shown in FIG. 8, the hopper volume 400 is an internal volume of the refuse compartment 30 and is defined by the left sidewall 402, the right sidewall 404, the hopper floor 406, the holding plate 408, and the packer 46. The left sidewall 402 extends longitudinally (e.g., in a direction extending between the cab 16 and the tailgate 34) between the holding plate 408 and the packer 46. The lift assembly 50 is arranged on the right sidewall 404. The hopper floor 406 extends horizontally (e.g., in a direction parallel to the ground on which the refuse vehicle 10 travels, etc.). between the left sidewall 402 and the right sidewall 404. In general, the hopper floor 406 is configured to support refuse contained in the hopper volume 400 prior to the refuse being transferred to the storage volume. The holding plate 408 extends downwardly (e.g., in a direction toward the frame 12, or in a direction perpendicular to the ground on which the refuse vehicle 10 travels) from a top wall of the refuse compartment 30. In general, the holding plate 408 separates the hopper volume 400 and the storage volume 500 and forms a partition between the two sections in the refuse compartment 30. In addition, the holding plate 408 aids in preventing refuse being packed into the storage volume 500 from falling back toward the hopper volume 400.

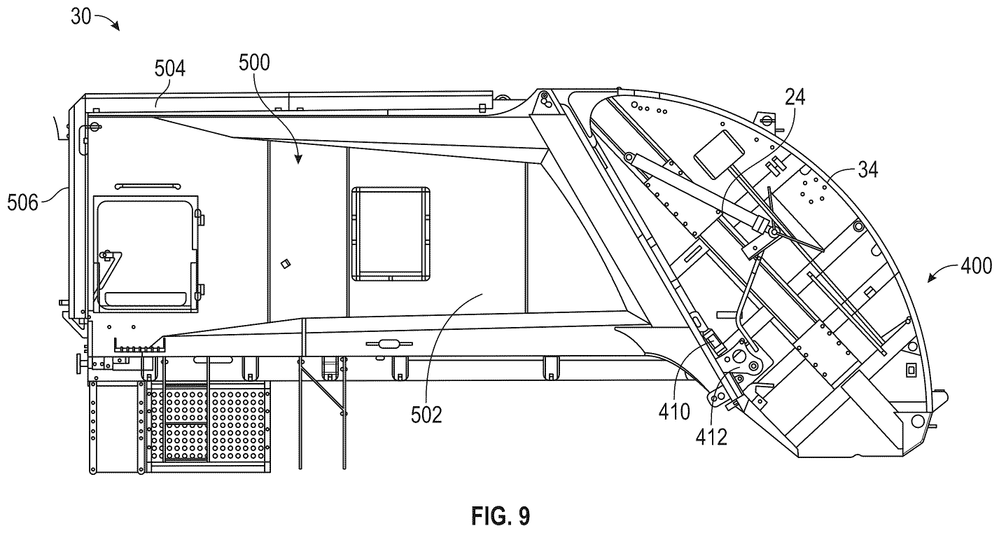

Referring to FIGS. 6 and 7, the storage volume 500 is an internal volume positioned in the refuse compartment 30 and is defined by panels 502 (e.g., the panels 32, etc.), a cover 504 (e.g., the cover 36, etc.), and the tailgate 34. According to the exemplar embodiment shown in FIG. 8, the storage volume 500 is further defined by the holding plate 408. According to the exemplary embodiment shown in FIG. 9, the storage volume 500 is further defined by a front panel 506.

According to the exemplary embodiment shown in FIG. 9, the tailgate 34 further includes a lock actuator 410. In some embodiments, the lock actuator 410 may be configured to rotate a locking flange 412 to lock the tailgate 34 in the closed position. In some embodiments, the lock actuator 410 is an electrically-driven linear actuator. For example, in some embodiments, the lock actuator 410 is one of a lead screw/lead nut type actuator, a lead screw/ball nut type actuator, a lead screw/roller nut type actuator, a linear motor, or any other suitable type of electrically-driven linear actuator.

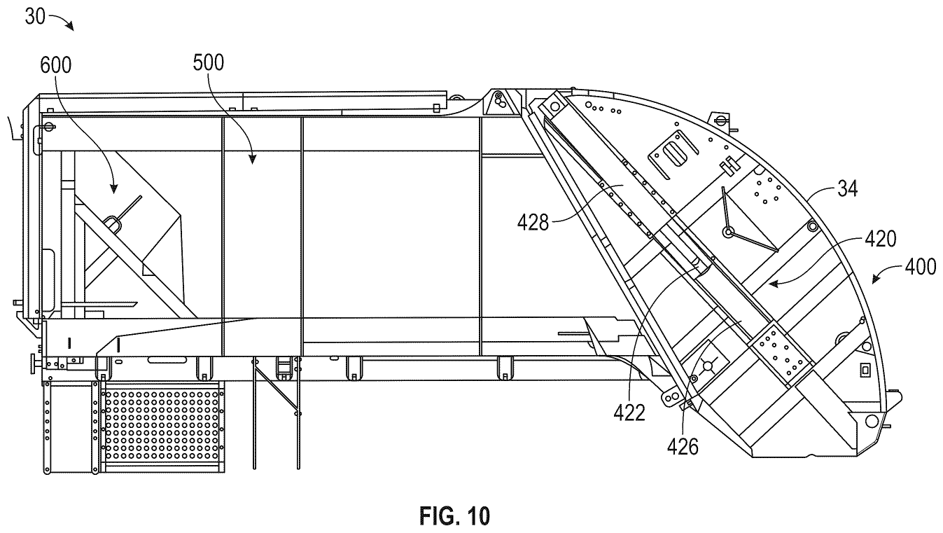

According to the exemplary embodiment shown in FIGS. 10-12, the tailgate compaction assembly 420 includes a carriage, shown as a slide 422, a compactor element, shown as a blade or a sweep 424, a track 426, a carriage actuator 428, and a compactor actuator (e.g., a linear compactor actuator 430 and/or a rotational compactor actuator 432). The slide 422 is coupled to and configured to move the sweep 424, along a track 426 to aid in the loading and/or packing of refuse into the storage volume 500. Specifically, the slide 422 is configured to move the sweep 424 along the track 426 between an extended position and a retracted or packing position using a carriage actuator 428. In some embodiments, the carriage actuator 428 is an electrically-driven linear actuator. For example, in some embodiments, the carriage actuator 438 is one of a lead screw/lead nut type actuator, a lead screw/ball nut type actuator, a lead screw/roller nut type actuator, a linear motor, or any other suitable type of electrically-driven linear actuator.

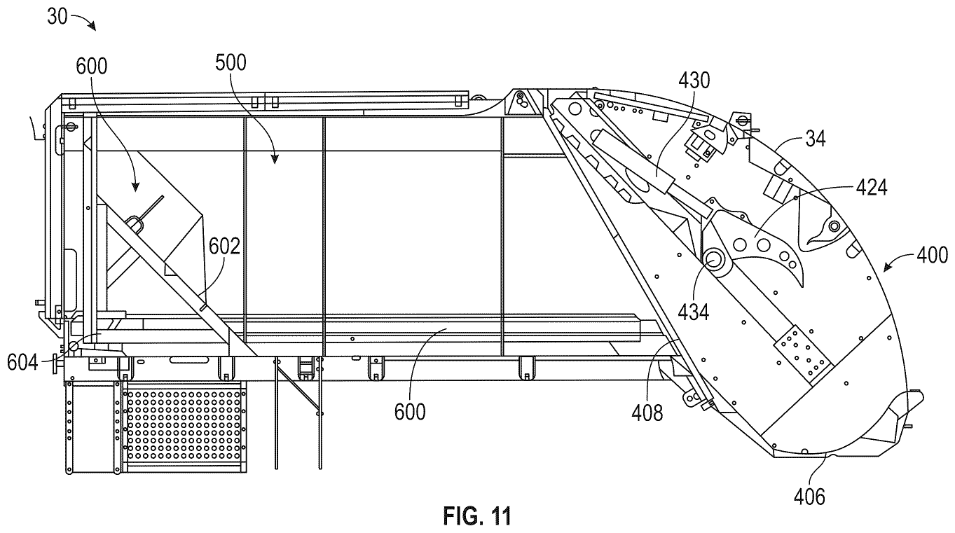

As shown in FIG. 11, the sweep 424 is rotatably coupled to the slide 422 at a joint 434. The sweep 424 is rotatable about the joint 434 between a closed position and an opened or receiving position using a linear compactor actuator 430. In the closed position, the sweep 424 is rotated clockwise (with respect to the illustrative embodiment provided in FIG. 11) to angle the sweep 424 toward the storage volume 500, such that the sweep 424 is configured to selectively pack refuse into the storage volume 500 by moving the sweep 424 from the extending position into the retracted or packing position. In the opened or receiving position, the sweep 424 is rotated counter-clockwise (with respect to the illustrative embodiment provided in FIG. 11) to angle the sweep 424 out of the storage volume 500 to provide clearance for inserting refuse into or removing refuse from the storage volume 500. In some embodiments, the linear compactor actuator 430 is an electrically-driven linear actuator. For example, in some embodiments, the linear compactor actuator 430 is one of a lead screw/lead nut type actuator, a lead screw/ball nut type actuator, a lead screw/roller nut type actuator, a linear motor, or any other suitable type of electrically-driven linear actuator.

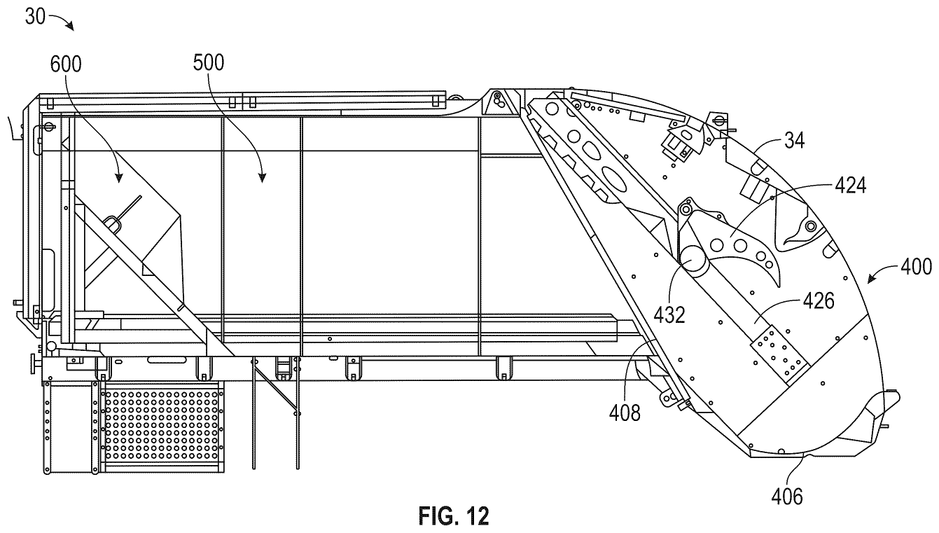

As shown in FIG. 12, in some embodiments, the sweep 424 is additionally or alternatively actuatable about the joint 434 by the rotational compactor actuator 432 (the joint 434 in FIG. 12 is disposed behind the rotational compactor actuator 432). The rotational compactor actuator 432 is rotationally engaged with the sweep 424 to move the sweep between the opened or receiving position and the closed position, as described above. In some embodiments, the rotational compactor actuator 432 is an electric motor configured to selectively rotate the sweep 424 a predetermined amount in either the clockwise or the counter-clockwise direction (with respect to the illustrative embodiment provided in FIG. 12).

As alluded to above, in some embodiments, the tailgate 34 may include only the linear compactor actuator 430. In other embodiments, the tailgate 34 may include only the rotational compactor actuator 432. In still other embodiments, the tailgate 34 may include both the linear compactor actuator 430 and the rotational compactor actuator 432 to provide additional closing force to the sweep 424, as necessary.

According to the exemplary embodiments shown in FIGS. 10-15, the refuse compartment 30 includes a packer system, shown as packer system 600. The packer system 600 is part of the compaction system 118 and is configured to pack (e.g., compress, etc.) refuse contained in the storage volume 500 to reduce the volume of the refuse (e.g., such that additional refuse may be stored in the storage volume 500, etc.). In some embodiments, the packer system 600 may also be configured to eject the refuse contained in the storage volume 500 (e.g., through the tailgate 34, etc.). For example, in a packing configuration, the tailgate 34 is in the closed position and the packer system 600 moves toward the tailgate 34, thereby compacting any refuse contained within the storage volume 500. In an ejecting configuration, the tailgate 34 is in the open position and the packer system 600 moves toward the tailgate 354, thereby ejecting any refuse contained within the storage volume 500. In some embodiments, the refuse compartment 30 includes both the tailgate compaction assembly 420 and the packer system 600 (e.g., the tailgate compaction assembly 420 transfers and compacts the refuse in the hopper volume 400 into the storage volume 500 and the packer system 600 compacts the refuse in the storage volume 500, the refuse compartment 30 includes multiple packer systems, etc.)

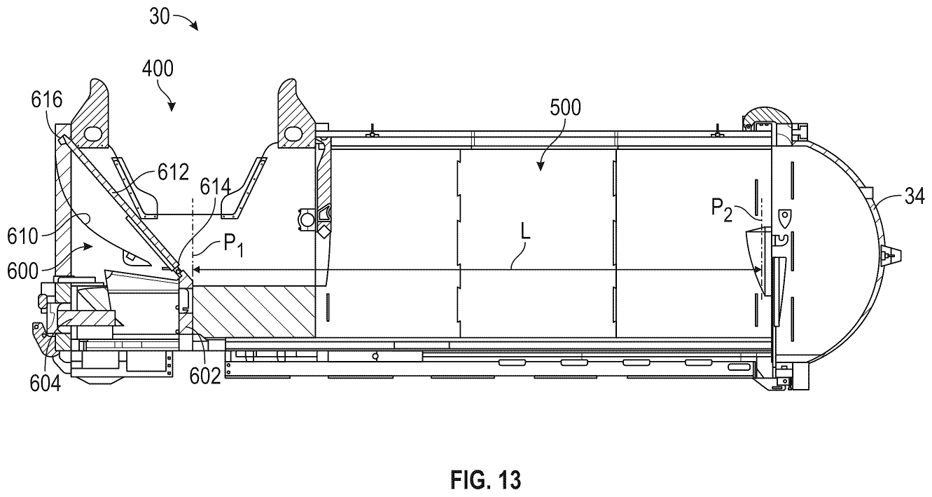

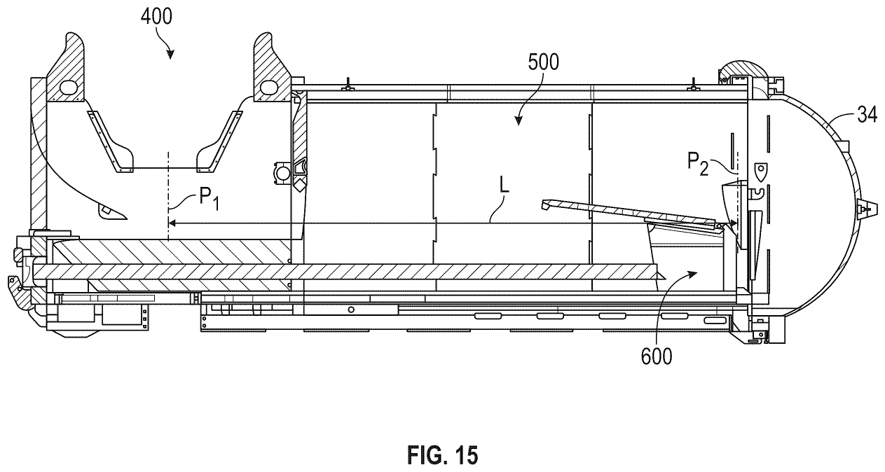

As shown in FIGS. 10-15, the packer system 600 includes a pack panel 602 and a packing actuator 604. The pack panel 602 faces in a direction toward the storage volume 500 (e.g., a normal extending from the outer surface of the pack panel 602 is directed toward the storage volume 500). The pack panel 602 is coupled to the packing actuator 604 so that the packing actuator 604 selectively moves the pack panel 602 between a retracted or home position (see, e.g., FIG. 13) and an extended or eject position (see, e.g., FIG. 15), between the extended position and the retracted position, and any position in between the extended position and the retracted position. In some embodiments, the packing actuator 604 is a telescoping actuator that is pneumatically, hydraulically, electronically, or electro-hydraulically driven. According to the exemplary embodiments shown in FIGS. 10-12, the pack panel 602 extends generally at an angle (e.g., in a direction at an angle to a road on which the vehicle 10 travels, etc.). According to the exemplary embodiments shown in FIGS. 13-15, the pack panel 602 extends generally vertically (e.g., in a direction perpendicular to a road on which the vehicle 10 travels).

According to the exemplary embodiment shown in FIGS. 10-12, the packer system 600 also includes an ejector track 606. The pack panel 602 is slidably coupled to the ejector track 606 such that the packing actuator 604 moves the pack panel 602 between a receiving position (e.g., a position for receiving refuse in the storage volume 500, etc.) and a packing position or an ejecting position.

According to the exemplary embodiments shown in FIGS. 13-15, the packer system 600 also includes a ramped or curved wall 610 and a pivot plate 612. A first end 614 of the pivot plate 612 is rotatably coupled to a distal end of the pack panel 602 so that the pivot plate 612 rotates relative to the pack panel 602 as the pack panel 602 moves between retracted and extended positions. A second end 616 of the pivot plate 612 is configured to engage and slide along the curved wall 610 (e.g., when the pack panel 602 is in a position where the second end 616 of the pivot plate 612 overlaps with the curved wall 610). The curved wall 610 defines a generally curved profile that ramps downwardly in a direction toward the storage volume 500.

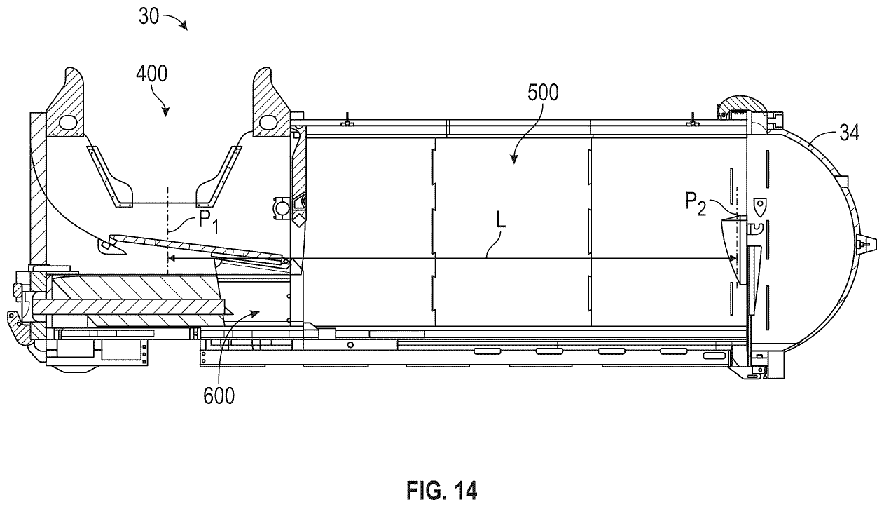

A packing procedure generally includes moving the pack panel 602 from the retracted position (see, e.g., FIG. 13) to a position where the pack panel 602 is at least partially extended from the retracted position in a direction toward the extended position (see, e.g., FIG. 14). According to the exemplary embodiment shown in FIG. 13, in the retracted position, the pack panel 602 is arranged at least partially within the hopper volume 400, and the packing procedure extends the pack panel 602 toward the storage volume 500 to compact and displace refuse in the hopper volume 400 in a direction toward the storage volume 500. This enables the hopper volume 400 to be repeatedly filled and packed until the storage volume 500 is full and an ejection procedure is required. According to the exemplary embodiments shown in FIGS. 10-12, in a retracted position, the pack panel 602 is positioned proximate a forward end of the storage volume 500 (e.g., a first end of the storage volume 500 positioned towards the direction of travel of the refuse vehicle 10, etc.), and the packing procedure extends the pack panel 602 toward a rearward end of the storage volume 500 (e.g., a second end of the storage volume 500 positioned away from the direction of travel of the refuse vehicle 10, etc.) to compact the refuse in the storage volume 500.

The ejection procedure generally includes moving the pack panel 602, via the packing actuator 604, to the extended or eject position (see, e.g., FIG. 15). During the ejection procedure, the tailgate 34 is opened and the pack panel 602 is moved to the extended position and refuse in the storage volume 500 is ejected. The movement of the pack panel 602 between the retracted position and the extended position defines a travel length or distance of the pack panel 602. According to the exemplary embodiment shown in FIGS. 13-15, in the retracted position, the pack panel 602 defines an initial plane P₁ and, in the extended position, the pack panel 602 defines a final plane P₂. A length L is defined between the initial plane P₁ and the final plane P₂ and represents the travel distance traversed by the pack panel 602 between the retracted and extended positions. In some embodiments, a forwardmost point of the pack panel 602 defines the initial plane P₁ in vertical direction perpendicular to the direction of travel of the refuse vehicle 10 (e.g., when the pack panel 602 does not extend generally vertically, etc.)

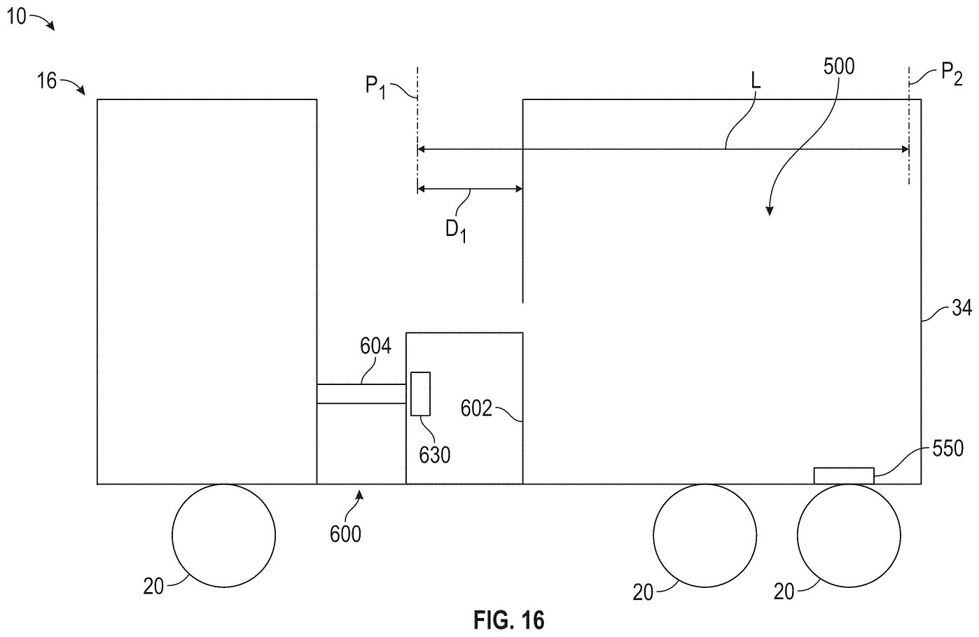

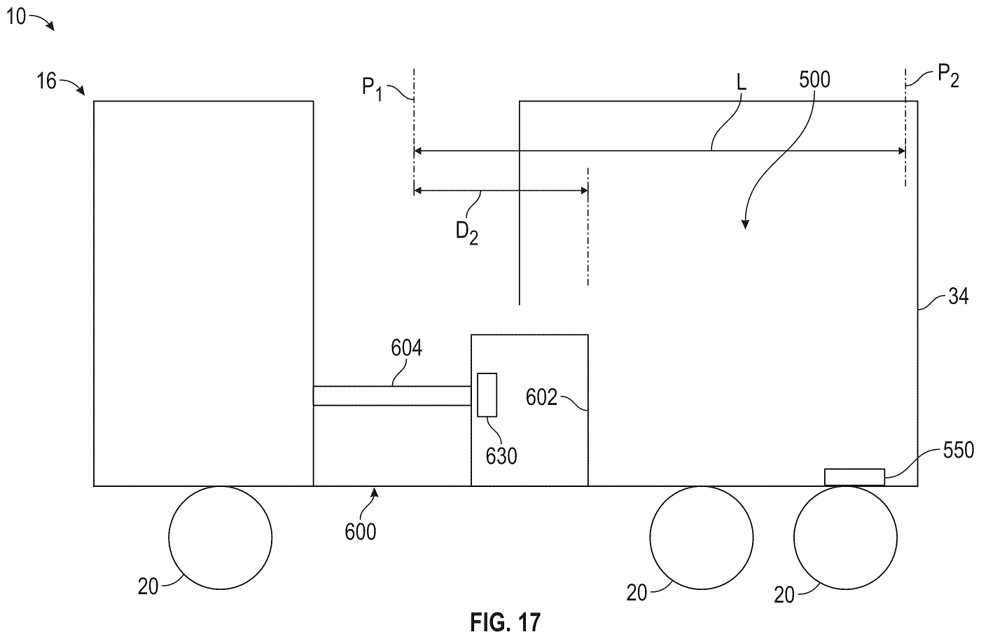

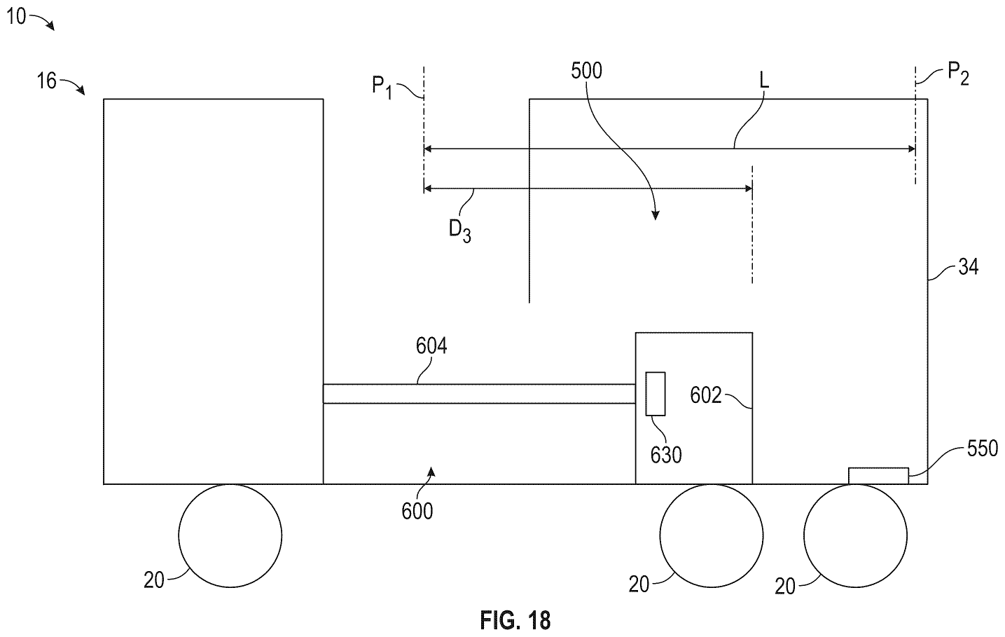

As described herein, the packing procedure generally includes moving the pack panel 602 from the retracted position to a position where the pack panel 602 is at least partially extended from the retracted position in a direction toward the extended position. The packing actuator 604 is configured to move the pack panel 602 to any position along the length L between the retracted position and the extended position. For example, turning to FIGS. 16-18, the packing actuator 604 is configured to move the pack panel 602 to a first position (FIG. 16), a second position (FIG. 17), or a third position (FIG. 18) along the length L. The second position is between the first position and the third position, and the first position is closer to the retracted position than the third position. In the first position, the pack panel 602 moves a first distance D₁ from the retracted position. The first distance D₁ is defined between the initial plane P₁ and the position of the pack panel 602 in the first position. In the second position the pack panel 602 moves a second distance D₂ from the retracted position. The second distance D₂ is defined between the initial plane P₁ and the position of the pack panel 602 in the second position. In the third position, the pack panel 602 moves a third distance D₃ from the retracted position. The third distance D₃ is defined between the initial plane P₁ and the position of the pack panel 602 in the third position. The first distance D₁ is less than the second distance D₂, and the second distance D₂ is less than the third distance D₃. In some embodiments, the first distance D₁ is between about 0% and about 35% of the length L, the second distance D₂ is between about 35% and 65% of the length L, and the third distance D₃ is between about 65% and about 100% of the length L.

During the packing procedure, the packing actuator 604 can extend the pack panel 602 to any one of the first position, the second position, the third position, or any other position between the retracted position and the extended position. According to the exemplary embodiment shown in FIG. 14, the packing actuator 604 extends the pack panel 602 to generally align with the holding plate 408 during the packing procedure. For example, a distance between the pack panel 508 and the initial plane P1 can be within about 2%, 5%, or 10% of a distance between the initial plane P1 and the pack panel 602 (e.g., a rear surface of the pack panel 602 that faces the storage volume 500). After the pack panel 602 extends away from the retracted position, the pack panel 602 returns to the retracted position to complete the packing procedure.

The packer system 600 is also configured to pack the refuse in the storage volume 500 with different densities (e.g., apply different pressures on the refuse in the storage volume 500 with the packing actuator 604 through the pack panel 602, etc.). For example, the packing actuator 604 may apply a first pressure on the refuse in the storage volume 500 when the refuse is made up of organics and the packing actuator 604 may apply a second pressure on the refuse in the storage volume 500 when the refuse is made up of recyclables. By packing the refuse in the storage volume 500 with different densities, the packer system 600 may ensure that a weight of the packed refuse is evenly spread across the storage volume 500. In some embodiments, the packer system 600 may include one of the multiple sensors 126, shown as packing sensor 630. In some embodiments, the packing sensor 630 may be coupled to the pack panel 602 or the packing actuator 604 and be configured to detect a pressure applied on the refuse in the storage volume 500 by the pack panel 602. In various embodiments, the packing sensor 630 may be configured to detect a force applied on the refuse in the storage volume 500 by the pack panel 602, a distance that the pack panel 602 moves from the retracted position, etc. In some embodiments, the storage volume 500 may include one of the multiple sensors 126, shown as storage sensor 550. In some embodiments, the storage sensor 550 may be configured to detect a weight of the refuse in the storage volume 500, a fill level of the refuse in the storage volume 500, a pressure applied by the refuse contained in the storage volume 500 on the refuse compartment 30, a distribution of the refuse across the storage volume 500, etc.

### Object Categorization System

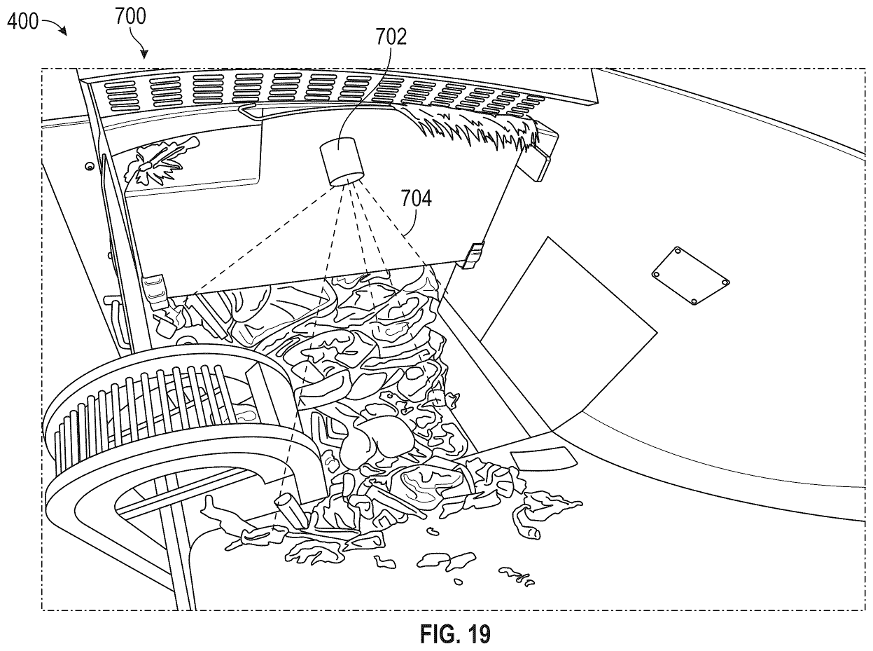

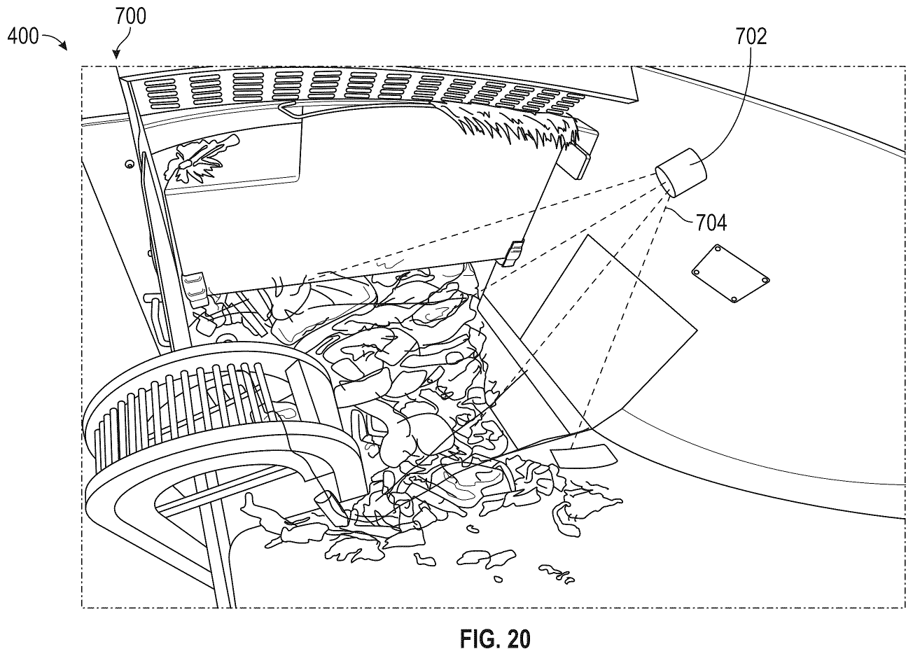

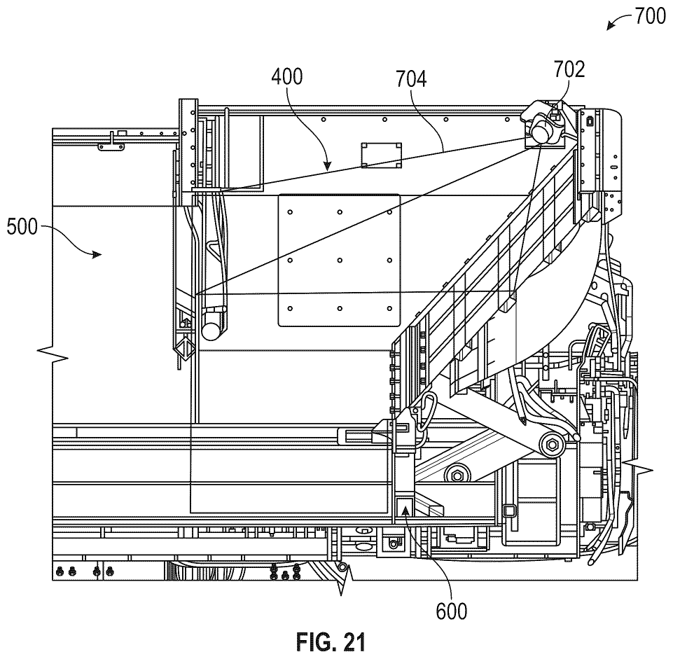

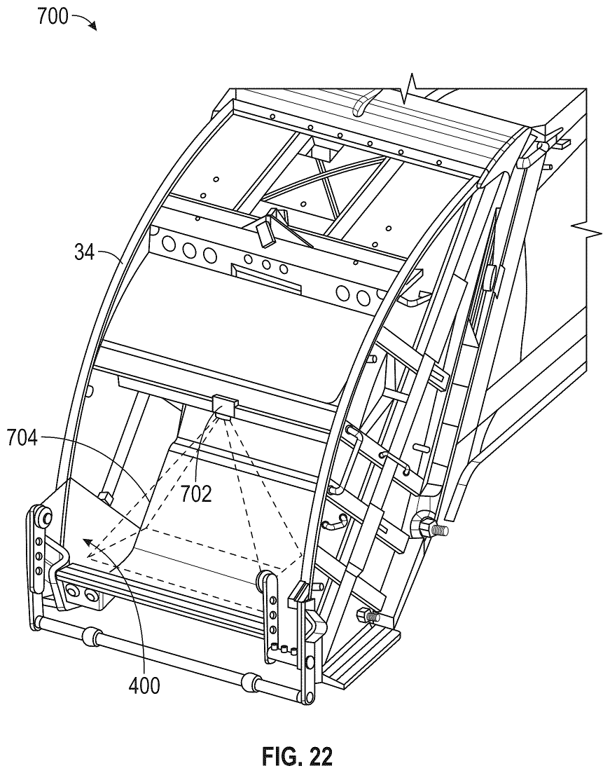

As shown in FIGS. 19-22, the vehicle 10 includes an object recognition system 700 (e.g., a refuse recognition system, a vision system, a refuse categorization system, etc.). The object recognition system 700 may be configured to identify (e.g., detect, etc.) categories of refuse received by the refuse vehicle 10. The object recognition system 700 may be configured to identify different categories of refuse (e.g., different types of refuse, different classifications of refuse, different such as garbage, recycling, organics, etc. In some embodiments, the object recognition system 700 may be configured to detect different categories of refuse containers such as garbage containers, recycling containers, residential containers, commercial containers, etc. The object recognition system 700 may use a variety of sensors, detectors, emitters, detection sub-systems, etc., to detect different categories of refuse or different categories of refuse containers. The object recognition system 700 may be similar to the system 600 for detecting a waste receptacle as described in greater detail in U.S. application Ser. No. 16/758,834, filed Apr. 23, 2020, the entire disclosure of which is incorporated by reference herein.

Still referring to FIGS. 19-22, the object recognition system 700 includes one or more cameras 702 configured to generate image data associated with objects (e.g., refuse, etc.) received by the refuse vehicle 10 and/or the refuse container that are handled by the refuse vehicle 10. The cameras 702 may be coupled to portions of the refuse compartment 30. The cameras 702 may be arranged so that a field of view 704 (e.g., a vision area, etc.) of the cameras 702 is directed toward the hopper volume 400, which may enable the cameras 702 to generate image data associated with the objects received by and/or contained within the hopper volume 400. In some embodiments, the cameras 702 are coupled to at least one of the left sidewall 402, the holding plate 408 the right sidewall 404, or the hopper floor 406 so that the cameras 702 are arranged to direct the field of view 704 toward the hopper volume 400 and the refuse therein. The cameras 702 may alternatively or additionally be positioned on the lift arms 42 of the refuse vehicle 10, on tailgate 34 of the refuse vehicle 10, etc. so that the cameras 702 are arranged to direct the field of view 704 toward objects that handled by the refuse vehicle 10 (e.g., refuse containers, etc.) or positioned proximate the refuse vehicle 10.

In use, according to some embodiments, the cameras 702 generate the image data by capturing real-time images inside of the hopper volume 400 as refuse is loaded into the hopper volume 400 (e.g., from the lift assembly 40, from the lift assembly 50, from the rear of the refuse vehicle 10, etc.). For example, the cameras 702 may capture real-time images as a refuse container is emptied into the hopper volume 400. The cameras 702 may alternatively or additionally generate the image data by capturing real-time images of an area surrounding the refuse vehicle 10. For example, the cameras 702 may capture real-time images of a refuse container being engaged by the lift assembly 50, a refuse container being engaged by the lift assembly 40, a refuse container being emptied into the hopper volume 400, etc.

It should be understood that the positioning and arrangement of the cameras 702 as described herein with reference to FIGS. 19-22 is illustrative only and is not intended to be limiting. For example, any of the cameras 702 may be disposed on a top of the cab 16 such that cameras 702 are configured to generate image data corresponding to a refuse container positioned forward of the refuse vehicle 10.

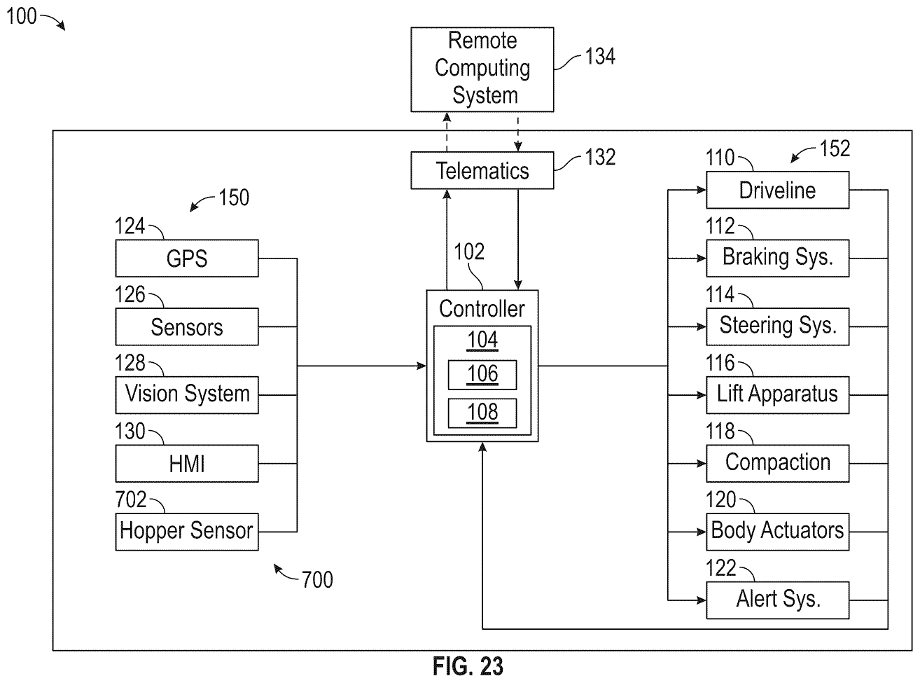

Referring to FIG. 23, the controller 102 may be configured to receive image data from the cameras 702 and use the image data to operate the alert system 122 or the compaction system 118 (e.g., the tailgate compaction assembly 420, the packer system 600, the tailgate compaction assembly 420 and the packer system 600, etc.). The controller 102 may communicate with the remote computing system 134 via the telematics unit 132. The controller 102 may upload any of the data obtained from the object recognition system 700, etc., to the remote computing system 134 and receive instructions from the remote computing system 134 (e.g., a packing density for a category of refuse, etc.). The controller 102 may use the instructions in combination with the data from the object recognition system 700 in order to operate the alert system 122 or the compaction system 118.

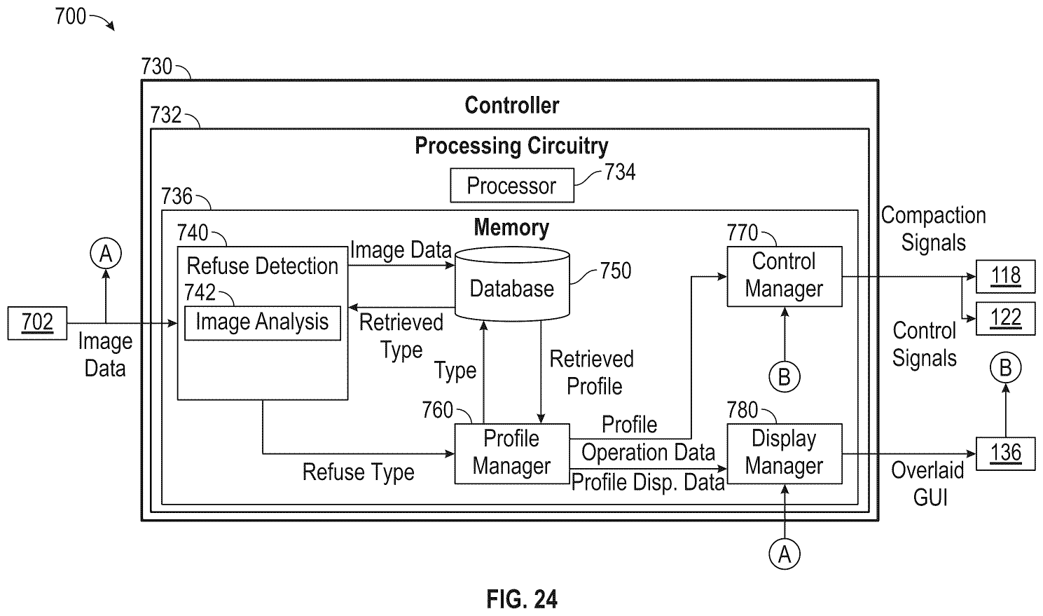

Referring to FIG. 24, a controller 730 is configured to receive the image data from the cameras 702. In some embodiments, the controller 730 is the controller 102. The controller 730 includes processing circuitry 732 including a processor 734 and memory 736. Processing circuitry 732 can be communicably connected with a communications interface of controller 730 such that processing circuitry 732 and the various components thereof can send and receive data via the communications interface. Processor 734 can be implemented as a general purpose processor, an application specific integrated circuit (ASIC), one or more field programmable gate arrays (FPGAs), a group of processing components, or other suitable electronic processing components.

Memory 736 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 736 can be or include volatile memory or non-volatile memory. Memory 736 can include database components, object code components, script components, or any other type of information structure for supporting the various activities and information structures described in the present application. According to some embodiments, memory 736 is communicably connected to processor 734 via processing circuitry 732 and includes computer code for executing (e.g., by at least one of processing circuitry 732 or processor 734) one or more processes described herein.

The memory 736 includes a refuse detection manager 740 that is configured to receive the image data from the cameras 702 and determine (e.g., detect, etc.) a refuse category. (e.g., a refuse attribute, a refuse parameter, a refuse categorization, a refuse type, etc.) associated with the objects depicted in the image data received from the cameras 702 that are positioned within the field of view 704 of the cameras 702 (e.g., within the hopper volume 400, etc.). For example, the refuse detection manager 740 may be configured to perform various analyses (e.g., image based analysis, etc.) based on the image data received from the cameras 702 in order to determine the refuse category associated with the object depicted in the image data. The refuse detection manager 740 is configured to implement an image analysis technique 742. The refuse category may be associated with a composition of the refuse (e.g., trash, recycling, compostables, electronic waste, bio waste, etc.), a destination of the refuse (e.g., a landfill, a composting facility, a recycling plant, etc.), and/or an origin of the refuse (e.g., a residential location, a commercial location, a residential customer, a commercial customer, etc.).

The image analysis technique 742 can include implementing image recognition technology (e.g., a neural network, machine learning, artificial intelligence, etc.) to identify the object depicted in the image data in order to determine the refuse category associated with the object. The image analysis technique 742 may use a database, shown as database 750, of predetermined objects and labels (e.g., trash bags, bottles, industrial waste, cans, tree branches, grass clippings, a recycling container, a residential container, a commercial container, etc., or any other categories of refuse or refuse container that may be commonly encountered by the refuse vehicle 10) in order to determine the refuse category associated with the object depicted in the image data. For example, if the image data from the cameras 702 includes a depiction of a trash bag, the image analysis technique 742 may use the refuse database 750 to identify the trash bag by matching the image data with reference image data that has been labeled as depicting a reference trash bag. The image analysis technique 742 may determine that a refuse category associated with the trash bag is a garbage refuse category based on the reference image data being labeled as corresponding to the garbage refuse category. As another example, if the image data from the cameras 702 depicts a blue recycling container, the image analysis technique 742 may use the database 750 to identify the blue recycling container by matching the image data with reference image data that has been labeled as depicting a reference blue recycling container. The image analysis technique 742 may determine that a refuse category associated with the blue recycling container is a recycling refuse category based on the reference image data being labeled as corresponding to the recycling refuse category. As yet another example, if the image data from the cameras 702 depicts a commercial refuse container, the image analysis technique may use the refuse database 750 to identify the commercial refuse container by matching the image data with reference image data that has been labeled as depicting a reference commercial refuse container. The image analysis technique 742 may determine that a refuse category associated with the commercial refuse container is a commercial refuse category based on the reference image data being labeled as corresponding to the commercial refuse category. In some embodiments, the image analysis technique 742 may determine that objects depicted in the image data corresponds to different refuse categories based on the image data depicting objects that correspond to each of the different refuse categories. For example, when the image data depicts a first object and a second object, the image data may determine that the first object corresponds to a recycling refuse category and that the second object corresponds to an organics refuse category.

The refuse detection manager 740 is configured to output the refuse category associated with the objects depicted in the image data to a profile manager 760. The profile manager 760 is configured to use the refuse categories of the objects in order to determine a packing profile (e.g., a compaction profile, a refuse category profile, at least one packing parameter, etc.) for the compaction system 118 of the refuse vehicle 10. The profile manager 760 may generate the packing profile by matching the refuse categories associated with the objects depicted in the image data with a reference packing profile associated with the refuse categories. The packing profile may include parameters associated with operation of the compaction system 118. For example, the packing profile may include a compaction pressure for the packing actuator 604 to apply on the refuse contained within the storage volume 500, an operational speed that the packing actuator 604 should move the pack panel 602, or a distance that the packing actuator 604 should move the pack panel 602. The profile manager 760 may use a database, shown as the database 750, of predetermined profiles (e.g., a garbage profile, a recycling profile, an organics profile, a commercial profile, a residential profile, etc.) in order to determine the packing profile for the compaction system 118. For example, if the refuse categories associated with the objects are organics, then the profile manager 760 may use the database 750 to determine that the packing profile associated with the objects depicted in the image data is an organics profile. The organics profile may include an organic compaction setting for the compaction system 118 associated with organics. In some embodiments, the profile manager 760 determines the profile based on the refuse category associated with the majority of the objects depicted in the image data. For example, if a majority of the objects depicted in the image data are associated with a garbage refuse category and a minority of the objects depicted in the image data are associated with a recycling refuse category, the profile manager 760 may determine that the packing profile for the compaction system 118 based on the objects depicted in the image data should be a garbage packing profile since the majority of the objects depicted in the image data are associated with the garbage refuse category.

Referring still to FIG. 24, the memory 736 further includes a control manager 770 and a display manager 780. The control manager 770 is configured to use outputs of the profile manager 760 (e.g., the results of the refuse detection manager 740) in order to implement operation (e.g., autonomous operation, etc.) of the vehicle 10. The control manager 770 is configured to receive the packing profile from the profile manager 760 as well as the refuse categories associated with the objects depicted in the image data from the profile manager 760 (e.g., as currently detected by the object recognition system 700).

The control manager 770 can generate compaction signals for the compaction system 118 based on the packing profile received from the profile manager 760. The control manager 770 may generate the compaction signals in order to cause or allow operation of the compaction system 118 or to limit (e.g., prevent, restrict, lock, etc.), operation of the compaction system 118. The control manager 770 may generate the compaction signals based on the packing profile received from the profile manager 760 to cause the operation of the compaction system 118 to correspond with the packing profile. For example, if the control manager 770 receives a recycling packing profile from the profile manager 760, the control manager 770 may operate the compaction system 118 with the compaction settings corresponding to the recycling packing profile that sets an operating pressure that the packer system 600 applies on the refuse in the storage volume 500 to a pressure that is optimal for recycling. In some embodiments, the control manager 770 may operate the compaction system 118 autonomously based on the packing profile received from the profile manager 760.

In some embodiments, the control manager 770 can generate alert signals for the alert system 122 based on the packing profile received from the profile manager 760. The control manager 770 may generate the alert signals in order to cause or allow the alert system 122 to provide an alert to individuals nearby the refuse vehicle 10. For example, the control manager 770 may generate an alert signal when the compaction setting of the compaction system 118 does not correspond with the packing profile determined by the profile manager 760. As another example, the control manager 770 may generate an alert signal when the packing profile received from the 760 does not include packing settings (e.g., the packing profile has not been defined, the packing profile is missing operational settings, etc.).

In some embodiments, the control manager 770 can cause the compaction system 118 to be operated in different preset operational modes based on the packing profile received from the profile manager 760 to more efficiently complete compaction of the refuse within the storage volume 500. For example, the same refuse vehicle 10 may be used to handle different refuse belonging to multiple of the refuse categories (e.g., recycling, garbage, organics, commercial, residential, etc.) and the operational mode for the compaction system 118 may change depending on the refuse category of the refuse that the refuse vehicle 10 is handling. In some embodiments, the operational modes may be included in the packing profiles. The present operational modes may be selected by the control manager 770 based on the packing profile received from the profile manager 760 to effectively deal with refuse belonging to each of the refuse categories. For example, when the packing profile received from the profile manager 760 is a recycling packing profile, the control manager 770 may select a recycling operational mode for the compaction system 118. Since re. cycling materials may be lightweight and loosely packed (or entirely unpacked) materials, the recycling operational mode may include operating the compaction system 118 at a greater frequency (e.g., the rate at which the packer 46 compacts the refuse within the storage volume 500, the rate at which the tailgate compaction assembly 420 compacts the refuse from the hopper volume 400 to the storage volume 500, etc.) than a garbage operational mode to improve the overall capacity of the refuse compartment 30 of the refuse vehicle 10 so that the refuse vehicle 10 can pick up additional refuse. The operation mode of the compaction system 118 set by the control manager 770 may also affect pressure applied by the compaction system 118 on the refuse within the storage volume 500 (e.g., the pressure applied by the packing actuator 604 on the refuse via the pack panel 602, etc.), the force applied by the compaction system 118 on the refuse within the storage volume 500 (e.g., the force applied by the packing actuator 604 on the refuse via the pack panel 602, etc.), the distance traveled by the pack panel 602 into the storage volume 500 (e.g., the distance that the packing actuator 604 pushes the pack panel 602 into the storage volume 500, etc.

In some embodiments, the control manager 770 can generate operational mode alert signals for the alert system 122 when the operational mode of the compaction system 118 does not match the profile pack received from the profile manager 760. For example, if the compaction system 118 is operating in a recycling operational mode and the profile manager 760 determines that the objects depicted in the image data (e.g., the objects positioned in the hopper volume 400, etc.) belong to a garbage packing profile, the control manager 770 may generate an operational mode alert signal and provide the operational mode alert signal to generate and provide an alert to individuals nearby the refuse vehicle 10 that the operational mode of the compaction system 118 does not match the pack profile corresponding to the objects depicted in the image data. As a result, an operator of the refuse vehicle 10 may change the operational mode of the compaction system 118 to the operational mode that matches the packing profile to ensure that the refuse contained withing the storage volume 500 is compacted according to the correct compaction settings.

The adjustability of the compaction system 118 may be similar to the adjustability of the weight distribution of the packed refuse as described in greater detail in U.S. application Ser. No. 10/943,182, filed Sep. 16, 2004, the entire disclosure of which is incorporated by reference herein. The execution of the operational modes may be similar to execution of the operational modes as described in greater detail in U.S. application Ser. No. 17/872,535, filed Jul. 25, 2022, the entire disclosure of which is incorporated by reference herein.

The display manager 780 is configured generate a graphical user interface (“GUI”) for an operator or user of the refuse vehicle 10 based on the results of the refuse detection manager 740. The display manager 780 is configured to obtain the results of the refuse detection manager 740 and produce graphical displays of any objects that are detected as being depicted within the image data. In some embodiments, the display manager 780 is configured to receive display data of the objects depicted in the image data from the profile manager 760. The display manager 780 is configured to produce displays of the display data such that the real-time images from the cameras 702 depicting the objects are displayed on the GUI of the display manager 780. The user interface 136 may be positioned locally at the refuse vehicle 10 or may be at a remote location (e.g., at an operator or technician center for fleet management purposes). In some embodiments, the GUI generated by the display manager 780 may include elements (e.g., text, videos, images, buttons, etc.) indicating a recommended operational mode of the compaction system 118. For example, if the profile manager 760 determines that the objects depicted in the image data belong to a garbage profile pack, the display manager 780 may generate the GUI with an element recommending that the compaction system 118 be placed in a corresponding garbage operational mode. In some embodiments, the elements included in the GUI may be actionable (e.g., part of a touch screen, a button, etc.) and a selection of one of the elements may place the compaction system 118 into one of the operational modes corresponding to the one of the elements. For example, the GUI may include a touch screen and one of the elements included in the GUI may correspond with a commercial operational mode. When a user of the GUI selects the one of the elements, the compaction system 118 may be placed in the commercial operational mode.

Referring still to FIG. 24, it should be understood that any of the functionality of the controller 730 may be implemented on the controller 102 of each of a fleet of refuse vehicles 10. In some embodiments, one or more functions of the controller 730 are implemented by the controller 102 and one or more functions of the controller 730 are implemented by the remote computing system 134 with which the controller 102 is in communication. In one example, the remote computing system 134 includes the database 750 and is configured to provide requested profiles to the controller 102 which implements the functionality of the refuse detection manager 740, the profile manager 760, the control manager 770, and the display manager 780. In another example, the remote computing system 134 is configured to implement all of the functionality of the controller 730 except the obtaining of the image data. The controller 102 may be responsible for obtaining, from the cameras 702, the image data, which are forwarded (e.g., via the telematics unit 132) to the remote computing system 134 which implements the functionality of the controller 730 as shown. The remote computing system 134 may provide the controller 102 with the compaction signals and the control signals such that the controller 102 can operate the compaction system 118 and the alert system 122. Accordingly, any of the functionality of the controller 730 may be performed in a distributed manner between the controller 102 and the remote computing system 134.

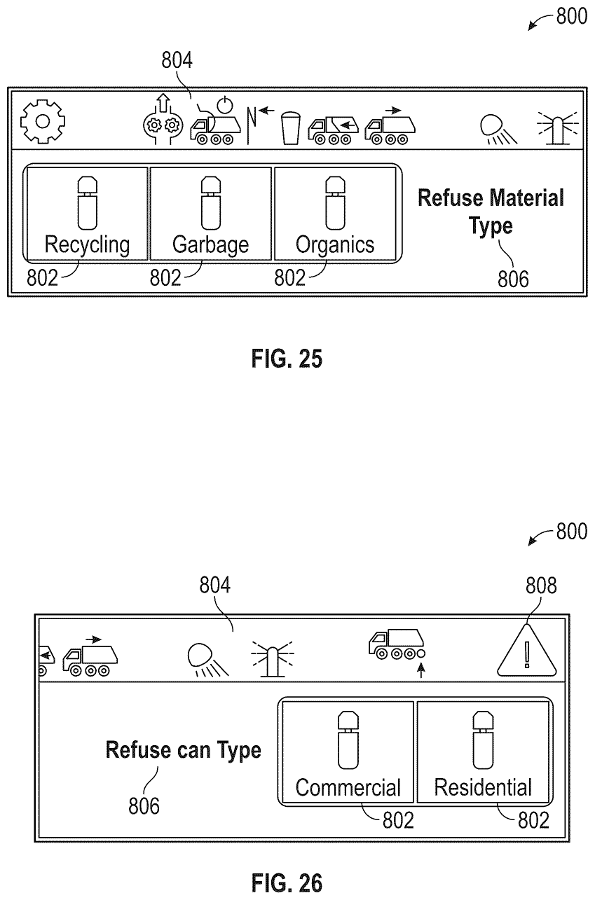

Referring to FIG. 25, an illustration of a configuration of a user interface 800 on the user interface 136 is shown. In some embodiments, the user interface 800 is generated and provided by the display manager 780 and provided to the user interface 136 to be displayed to a user.

As illustrated, the user interface 800 includes a plurality of operational mode indicators 802, a plurality of status indicators 804, and an operational indicator 806. The operational mode indicators 802 displays content related to the operational modes of the compaction system 118 so that the user may identify each of the operational modes. The content related to the operational modes may include descriptions of the operational modes, photographs corresponding to the operational modes, videos corresponding to the operational modes, or other elements that may relate to the operational modes. For example, the operational mode indicators 802 may display content relating to operating modes and/or packing profiles associated with refuse categories of refuse received by the refuse vehicle such as a garbage operating mode, a garbage packing profile, a recycling operating mode, a recycling packing profile, an organics operating mode, an organics packing profile, an operating mode relating to a different refuse category, and/or a packing profile relating to the different refuse category. As another example, the operational mode indicators 802 may display content relating operating modes and/or packing profiles associated with refuse categories of refuse containers handled by the refuse vehicle such as a residential operating mode, a residential packing profile, a commercial operating mode, a commercial packing profile, an operating mode relating to a different refuse container category, and/or a packing profile relating to a difference refuse container category.

In some embodiments, the operational mode indicators 802 may include a variety of other text-based, color-based, or symbol-based indicators indicative of a status of the operational modes of the compaction system 118. For example, the operational mode indicators 802 may include one or more of a color-coded indicator (e.g., a red indicator that an operational mode is not active, a yellow indicator that an operational mode is active but does not match the packing profile, a green indicator that an operational mode is active and matches the packing profile, etc.), a predetermined shape-based symbol (e.g., a plus sign indicator that an operational mode is active and matches the packing profile, a minus sign indicator that an operational mode is active and does not match the packing profile, etc.), or any other suitable type of operational mode indicators 802.

In some embodiments, one or more of the operational mode indicators 802 may be one or more actionable (e.g., interactable, etc.) buttons or items that influence the operational mode of the compaction system 118. For example, the selection of one of the operational mode indicators 802 may place the compaction system 118 in the operational mode that corresponds with the one of the operational mode indicators 802. For example, if a user selects the operational mode indicator 802 that corresponds with a recycling operational mode, the compaction system 118 may be placed in the recycling operational mode. As another example, the selection of one of the operational mode indicators 802 may place the compaction system 118 in the operational mode that corresponds with the packing profile associated with the objects depicted in the image data.

The plurality of status indicators 804 displays content related to the operation of the refuse vehicle 10. For example, the status indicators 804 may include a fuel gage that indicates a quantity of fuel for the refuse vehicle 10 that remains in a fuel tank, a battery gage that indicates a quantity of electricity for the refuse vehicle 10 that remains in a battery, a storage volume indicator that indicates how much space is available within the storage volume 500, etc. The operational indicator 806 displays descriptive text relating to the operational mode indicators 802. For example, the operational indicator 806 may include descriptive text that details the refuse categories associated with the operational modes corresponding to the operational mode indicators 802 included in the user interface 800 (e.g., “refuse material category” when the operational mode indicators 802 correspond with operational modes that relate to the refuse categories of refuse, “refuse container category” when the operational mode indicators 802 correspond with operational modes that relate to the refuse categories of refuse containers, etc.).

Referring to FIG. 26, an illustration of a configuration of a user interface 800 on the user interface 136 is shown. In some embodiments, the user interface 800 is generated and provided by the display manager 780 and provided to the user interface 136 to be displayed to a user.

As illustrated, the user interface 800 the operational mode indicators 802, the status indicators 804, the operational indicator 806, and an operational mode alert indicator 808. The operational mode alert indicator 808 may display an alert when the operational mode of the compaction system 118 does not correspond with the profile pack determined by the profile manager 760 based on the image data. For example, the operational mode alert indicator 808 may indicate that the compaction system 118 is operating in a garbage operational mode, but that the profile manager 760 has determined that the packing profile associated with refuse depicted in the image data is a recycling packing profile. As another example, the operational mode alert indicator 808 may indicate that the compaction system 118 is operating in a residential operational mode, but that the profile manager 760 has determined that the packing profile associated with a refuse container proximate the refuse vehicle 10 is a commercial packing profile.

Referring to FIG. 26, an illustration of a configuration of a user interface 800 on the user interface 136 is shown. In some embodiments, the user interface 800 is generated and provided by the display manager 780 and provided to the user interface 136 to be displayed to a user.

As illustrated, the user interface 800 the operational mode indicators 802, the status indicators 804, the operational indicator 806, and an operational mode alert indicator 808. The operational mode alert indicator 808 may display an alert when the operational mode of the refuse vehicle 10 does not correspond with the profile pack determined by the profile manager 760 based on the image data. For example, the operational mode alert indicator 808 may indicate that the refuse vehicle 10 is operating in a garbage operational mode, but that the profile manager 760 has determined that the packing profile associated with the refuse contained in the hopper volume 400 (e.g., the refuse depicted in the image data, etc.) is a recycling packing profile. As another example, the operational mode alert indicator 808 may indicate that the refuse vehicle 10 is operating in a residential operational mode, but that the profile manager 760 has determined that the packing profile associated with a refuse container proximate the refuse vehicle 10 (e.g., the refuse container depicted in the image data, etc.) is a commercial packing profile.

### Process for Determining Pack Profile

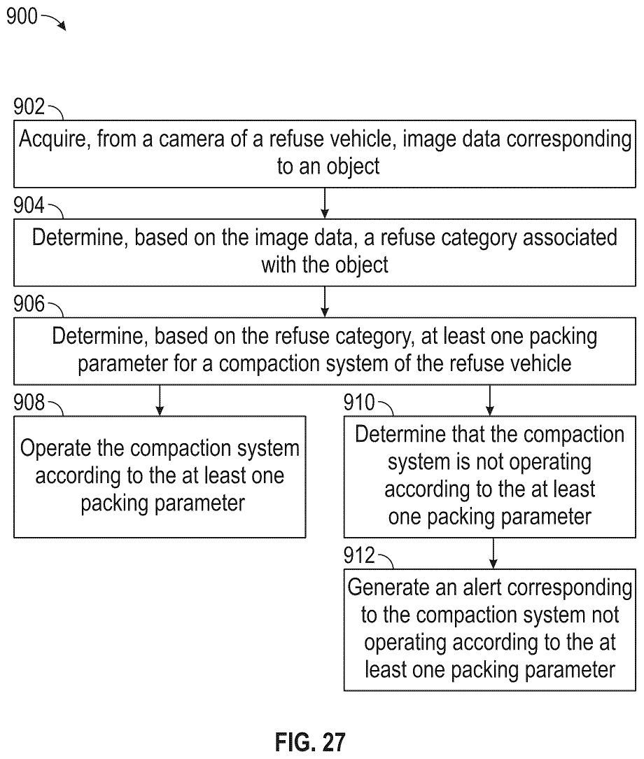

Referring to FIG. 27, a flow diagram of a process 900 for determining a pack profile for a compaction system of a refuse vehicle using image data includes steps 902-912, according to some embodiments. In some embodiments, the process 900 is performed by the controller 102 based on data obtained from one or more of the input devices 150 of the refuse vehicle 10. In some embodiments, the process 900 is performed by the controller 730 based on data obtained from the object recognition system 700 of the refuse vehicle 10. The process 900 may be implemented in order to operate the compaction system 118 of the refuse vehicle 10 according to a packing profile associated with a refuse category and/or to alert an operator of the refuse vehicle 10 that the refuse vehicle 10 is not being operating according to the packing profile associated with the refuse category.

The process 900 includes acquiring, from a camera of a refuse vehicle, image data corresponding to an object (step 902), according to some embodiments. Step 902 can be performed by the controller 102 by acquiring image data from one or more of the input devices 150 or the cameras 702 of the object recognition system 700. The image data correspond to (e.g., depict, etc.) objects contained within the hopper volume 400 of the refuse compartment 30. For example, the image data received by the controller 102 may include images of refuse contained within the hopper volume 400. In some embodiments, the image data correspond to refuse containers that are being handled by the refuse vehicle 10 and/or that are positioned proximate the refuse vehicle 10. For example, the image data received by the controller 102 may include images of a refuse container being handled by the lift assembly 40 or positioned next to the refuse vehicle 10.

The process 900 includes determining, based on the image data, a refuse category associated with the object (step 904), according to some embodiments. Step 904 can be performed by the controller 102 based on the image data received from the one or more of the input devices 150. In some embodiments, the image data may be received from the cameras 702 and the image data may correspond to the object that is located within the fields of view 704 of the cameras 702. In some embodiments, the controller 102 may determine the refuse category associated with the object by implementing image recognition technology (e.g., a neural network, machine learning, artificial intelligence, etc.) to identify the objects the objects so that the refuse category can be assigned to the objects. For example, the controller 102 may identify that a trash bag is depicted in the image data and determine that the refuse category associated with the trash bag is a garbage refuse category. As another example, the controller 102 may determine identify that a commercial container is depicted in the image data and determine that the refuse category associated with the commercial container is a commercial refuse category. In some embodiments, the refuse category associated with the object may be determined by the refuse detection manager 740 using the image analysis technique 742.

The process 900 includes determining, based on the refuse category, at least one packing parameter for a compaction system of the refuse vehicle (step 906), according to some embodiments. Step 906 can be performed by the controller 102 based on the refuse category determined in step 904. The at least one packing parameter may be an operational parameter of the compaction system 118 of the refuse vehicle 10. For example, the packing parameter may be a rate for operating the compaction system 118 based on the refuse category associated with the object, a pressure for operating the compaction system 118 based on the refuse category associated with the object, etc. In some embodiments, the packing parameter may correspond with the refuse category of a majority of the objects depicted in the image data. For example, the image data may correspond to objects contained within the hopper volume 400 of the refuse compartment 30 and step 904 may be determined that the objects are associated with different of the refuse categories. The packing parameter may correspond with the refuse category of the majority of the objects contained within the hopper volume 400. In some embodiments, step 906 includes determining a first packing profile corresponding with the refuse category associated with the object. The first packing profile may include multiple of the packing parameters (e.g., a speed, a maximum pressure, a maximum force, a distance, etc.).

The process 900 includes operating the compaction system according to the at least one packing parameter (step 908), according to some embodiments. Step 908 can be performed by the controller 102 based on the packing parameter determined in step 906. For example, the packing parameter may be a rate for operating the compaction system 118 and the controller 102 may operating the compaction system 118 according to the rate. In some embodiments, the controller 102 may place the refuse vehicle 10 in an operational mode corresponding with the packing parameter. The operational mode may include a preselected operational parameter corresponding with the refuse category. For example, the controller 102 may place the refuse vehicle 10 in a recycling operational mode to operate the refuse vehicle 10 according to a recycling packing parameter. In some embodiments, step 908 includes operating the compaction system of the refuse vehicle according to the packing profile determined during step 906. For example, the compaction system of the refuse vehicle may be placed in an operational mode corresponding to the packing profile such that the compaction system is operated according to the packing profile.

The process 900 includes determining that the compaction system is not operating according to the at least one packing parameter (step 910), according to some embodiments. Step 910 can be performed by the controller 102 based on the packing parameter determined in step 906 and an operating parameter of the refuse vehicle 10. For example, the packing parameter may be a first rate of operation for the compaction system 118 and the refuse vehicle 10 may be operating the compaction system 118 at a second rate. The controller 102 may determine that the refuse vehicle 10 is not operating with the second rate of operation that is packing parameter. In some embodiments, the controller 102 may determine that the refuse vehicle 10 is not placed in an operational mode corresponding to the packing parameter. For example, the packing parameter may correspond to a first operational mode associated with garbage and the refuse vehicle 10 may be placed in a second operational mode associated with recycling. The controller 102 may determine that the refuse vehicle 10 is not operating according to the packing parameter since the refuse vehicle 10 is placed in the second operational mode instead of the first operational mode. In some embodiments, step 910 includes determining that the refuse vehicle is not operating according to the packing profile determined during step 906. For example, the packing profile may correspond to a first operational mode associated with commercial refuse and the refuse vehicle may be operating according to a second operational mode associated with residential refuse.

The process 900 includes generating an alert corresponding to the compaction system not operating according to the at least one packing parameter (step 912), according to some embodiments. Step 910 can be performed by the controller 102 based on the determination that the refuse vehicle 10 is not operating according to the packing parameter determined in step 910. The controller 102 may generate an alert for the alert system 122 to notify an operator of the refuse vehicle 10 that the refuse vehicle 10 is not operating according to the packing parameter. In some embodiments, the controller 102 may operate the user interface 142 to display an alert to a user of the user interface 142 that the vehicle 10 is not operating according to the packing parameter. In some embodiments, step 912 includes generating the alert corresponding to the refuse vehicle not operating according to the packing profile determined during step 906 (e.g., when it is determined during step 910 that the refuse vehicle is not operating according to the packing profile, etc.). In other embodiments, the alert may be provided to the HMI 130 such that an operator of the refuse vehicle 10 may be notified that the compaction system 118 is not being operated according to the packing profile and may operate the compaction system 118 according to the packing profile.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body coupled to the chassis, the body defining a refuse compartment configured to store refuse therein;
a compaction system configured to compact the refuse stored within the refuse compartment;
a camera; and
one or more processing circuits configured to:
acquire, from the camera, image data corresponding to an object associated with refuse acquired by the refuse vehicle;
determine, based on the image data, a refuse category associated with the object;
determine, based on the refuse category, a first packing profile for the compaction system, the first packing profile including at least one packing parameter associated with operation of the compaction system; and
operate the compaction system according to the first packing profile.

2. The refuse vehicle of claim 1, wherein while operating the compaction system based on the first packing profile, the one or more processing circuits are further configured to:
determine that the compaction system is being operated according to a second packing profile that is different from the first packing profile; and
generate and provide an alert to an operator of the refuse vehicle.

3. The refuse vehicle of claim 2, wherein prior to operating the compaction system based on the first packing profile, the one or more processing circuits are configured to receive, from the operator of the refuse vehicle, a user input associated with operating the compaction system according to the first packing profile.

4. The refuse vehicle of claim 1, wherein:
the refuse compartment includes:
a hopper volume configured to receive refuse; and
a storage volume configured to store refuse;
the compaction system is configured to compact the refuse stored within the storage volume; and
a field of view of the camera is oriented toward the hopper volume such that the object is refuse positioned within the hopper volume.

5. The refuse vehicle of claim 4, wherein the refuse category is at least one of a recycling refuse category, a garbage refuse category, or an organics refuse category.

6. The refuse vehicle of claim 1, further comprising:
a lift arm system configured to engage a refuse container and transfer refuse from the refuse container into the refuse compartment;
wherein a field of view of the camera is oriented toward a portion of the lift arm system such that the object is the refuse container engaged by the lift arm system.

7. The refuse vehicle of claim 6, wherein the refuse category is at least one of a commercial refuse category or a residential refuse category.

8. The refuse vehicle of claim 1, wherein the at least one packing parameter is at least one of a speed of the compaction system, a frequency of the compaction system, or a pressure applied by the compaction system on the refuse stored within the refuse compartment.

9. A compactor control system for a refuse vehicle, the compactor control system comprising:
a compaction actuator configured to compact refuse stored within a refuse compartment of a refuse vehicle;
a camera; and
one or more processing circuits communicably coupled to the compaction actuator and the camera, the one or more processing circuits configured to:
acquire, from the camera, image data corresponding to an object associated with refuse acquired by the refuse vehicle;
determine, based on the image data, a refuse category associated with the object;
determine, based on the refuse category, a first packing profile for the compaction actuator, the first packing profile including at least one packing parameter associated with operation of the compaction actuator; and
operate the compaction actuator according to the first packing profile.

10. The compactor control system of claim 9, wherein:
a first portion of the one or more processing circuits configured to operate the compaction actuator is positioned on the refuse vehicle; and
a second portion of the one or more processing circuits configured to determine the refuse category is positioned remote from the refuse vehicle.

11. The compactor control system of claim 9, wherein while operating the compaction actuator based on the first packing profile, the one or more processing circuits are configured to:
determine that the compaction actuator is being operated according to a second packing profile different from the first packing profile; and
generate and provide an alert to an operator of the refuse vehicle.

12. The compactor control system of claim 11, wherein prior to operating the compaction actuator based on the first packing profile, the one or more processing circuits are configured to:
receive, from the operator of the refuse vehicle, a user input associated with operating the compaction actuator according to the first packing profile.

13. The compactor control system of claim 9, wherein:
the refuse compartment includes:
a hopper volume configured to receive refuse, and
a storage volume configured to store refuse;
the compaction actuator is configured to compact the refuse stored within the storage volume; and
a field of view of the camera is oriented toward the hopper volume such that the object is refuse positioned within the hopper volume.

14. The compactor control system of claim 9, wherein the refuse vehicle comprises:
a lift arm system configured to engage a refuse container and transfer refuse from the refuse container into the refuse compartment; and
a field of view of the camera is oriented toward a portion of the lift arm system such that the object is the refuse container engaged by the lift arm system.

15. The compactor control system of claim 9, wherein the at least one packing parameter is at least one of a speed of the compaction actuator, a frequency of the compaction actuator, or a pressure applied by the compaction actuator on the refuse stored within the refuse compartment.

16. The compactor control system of claim 9, wherein while operating the compaction actuator based on the first packing profile, the one or more processing circuits are configured to:
determine that the compaction actuator is being operated according to a second packing profile different from the first packing profile; and
adjusting the compaction actuator to be operated according to the first packing profile.

17. A method for operating a compaction system of a refuse vehicle, the method comprising:
acquiring, from a camera, image data corresponding to an object positioned within a refuse compartment of the refuse vehicle;
determining, based on the image data, a refuse category associated with the object;
determining, based on the refuse category, a first packing profile for the compaction system, the compaction system configured to compact refuse stored within the refuse compartment; and
operating the compaction system according to the first packing profile.

18. The method of claim 17, wherein while to operating the compaction system based on the first packing profile, the method comprises:
determining that the compaction system is being operated according to a second packing profile different from the first packing profile; and
adjusting the compaction system to be operated according to the first packing profile.

19. The method of claim 18, wherein prior to operating the compaction system based on the first packing profile, the method includes:
receiving, from an operator of the refuse vehicle, a user input associated with operating the compaction system according to the first packing profile.

20. The method of claim 17, wherein the refuse category is determined by matching the image data corresponding to the object with reference image data corresponding to a reference object that is associated with the refuse category.
